(19) United States
(12) Patent Application Publication
(10) Pub. No.: US 2011/0082606 A1
(43) Pub. Date: Apr. 7, 2011

(54) VEHICLE SUSPENSION CONTROL SYSTEM AND METHOD

(75) Inventors: Ajith Kuttannair Kumar, Erie, PA (US); Bret Worden, Erie, PA (US); Jeremy Thomas McGarry, Erie, PA (US)

(73) Assignee: GENERAL ELECTRIC COMPANY, Schenectady, NY (US)

(21) Appl. No.: 12/574,929

(22) Filed: Oct. 7, 2009

(51) Int. Cl. B61F 5/36; G05D 1/02

(52) U.S. Cl. 701/19; 105/209

(57) ABSTRACT

Methods and systems are provided for controlling a vehicle having a first truck with a first lift mechanism and a second truck with a second lift mechanism, each of the first and second trucks further configured with a plurality of axles, each of the first and second lift mechanisms configured to dynamically transfer weight from one axle to another. In one embodiment, the method comprises, responding to an operating condition by adjusting the first lift mechanism different from the second lift mechanism.

### FIELD

The subject matter disclosed herein relates to a method and system for controlling a lift mechanism in a vehicle.

### BACKGROUND

Vehicles, such as diesel-electric locomotives, may be configured with truck assemblies including two trucks per assembly, and three axles per truck. The three axles may include at least one powered axle and at least one non-powered axle. The axles may be mounted to the truck via lift mechanisms (such as, suspension assemblies including one or more springs) for adjusting a distribution of locomotive weight (including a locomotive body weight and a locomotive truck weight) between the axles. Weight distribution among the powered and non-powered axles may be performed statically and/or dynamically by adjusting a lift command. Under some operating conditions, while the commanded lift may be technically achievable, it may however adversely affect the locomotive truck or rail or other infrastructure. For example, a lift commanded in the presence of wheel slip may lead to increased stress on the truck and axle of the slipping wheel, thereby reducing the useful life of the component and reducing the performance of the system. Similarly, a lift commanded when the locomotive is operating on a gradient may lead to increased stress on rear truck components when going uphill and increased stress on front truck components when going downhill. Further still, the different trucks may have differing degrees of wear and thus the amount of lift each truck can support may accordingly vary. As such, potential issues may arise from the unbalanced stress generated on the front and back trucks, axles, wheels, and lift mechanism components.

### BRIEF DESCRIPTION OF THE INVENTION

Methods and systems are provided for controlling a vehicle having a first truck with a first lift mechanism and a second truck with a second lift mechanism, each of the first and second trucks further configured with a plurality of axles, each of the first and second lift mechanisms configured to dynamically transfer weight from one axle to another. In one embodiment, the method may comprise responding to an operating condition by adjusting the first lift mechanism different from the second lift mechanism.

In one embodiment, adjusting the first lift mechanism different from the second lift mechanism may include adjusting the first lift mechanism to increase lift while adjusting the second lift mechanism to reduce lift. In another embodiment, the adjustment may include adjusting the first lift mechanism and not the second lift mechanism. In still another embodiment, the adjustment may include adjusting the second lift mechanism and not the first lift mechanism. In yet another embodiment, the adjustment may include adjusting the first lift mechanism to increase lift by a first, larger amount and adjusting the second lift mechanism to increase the lift by a second, smaller amount. In this way, it may be possible to generate lift command adjustments that account for the variations in stress, wear, etc. from between the different trucks to thereby better control dynamic vehicle weight redistribution and maintain life expectancy of the overall system.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a vehicle comprising a lift mechanism enabling dynamic vehicle weight management (DWM),

FIG. 2 illustrates a sectional view of an example truck including the truck lift mechanism,

FIG. 3 illustrates an example pneumatic actuation of the lift mechanism of FIG. 2,

FIG. 4 shows a high level flow chart of a method for selecting an amount of lift in a vehicle truck lift mechanism according to the present disclosure,

FIG. 5 shows a high level flow chart of a method for adjusting the vehicle lift mechanism in response to dump conditions,

FIG. 6 shows a high level flow chart of a method for determining a truck command for the truck lift mechanism according to the present disclosure,

FIG. 7 shows a schematic diagram of an embodiment of a vehicle lift mechanism control system for selecting a truck and determining a truck command according to the present disclosure, and

FIG. 8 shows example truck commands based on example locomotive operating conditions.

### DETAILED DESCRIPTION

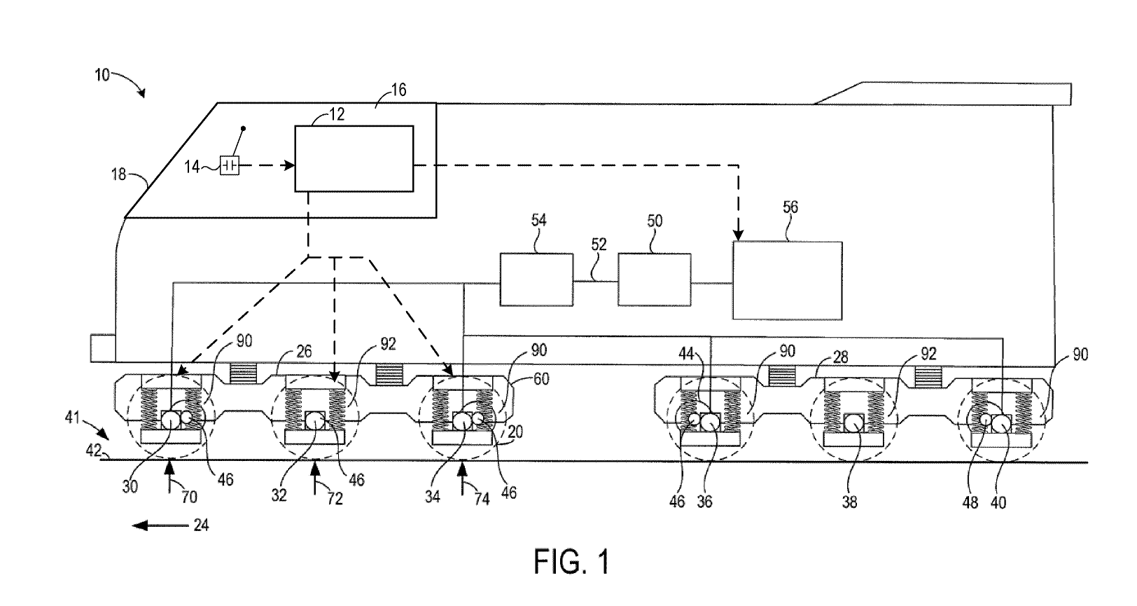

Vehicles, such as locomotives, may be configured with truck assemblies including lift mechanisms (such as, suspension systems) for transferring weight among wheels and/or axles supporting the locomotive. One example of such a mechanism is illustrated with reference to FIGS. 1-3. The mechanism enables dynamic weight management (DWM), that is, enables the weight (of the locomotive) on each truck to be selectively, and dynamically, redistributed among powered and un-powered axles responsive to vehicle and truck operating conditions. For example, during a “DWM lift”, such a mechanism permits a tractive force (from the locomotive on to the rail) to be increased by distributing a supported load from an un-powered to a powered axle when traction is desired. Likewise, during a “DWM de-lift”, such a mechanism permits the supported load to be more evenly distributed among the powered and un-powered axles when less traction is desired.

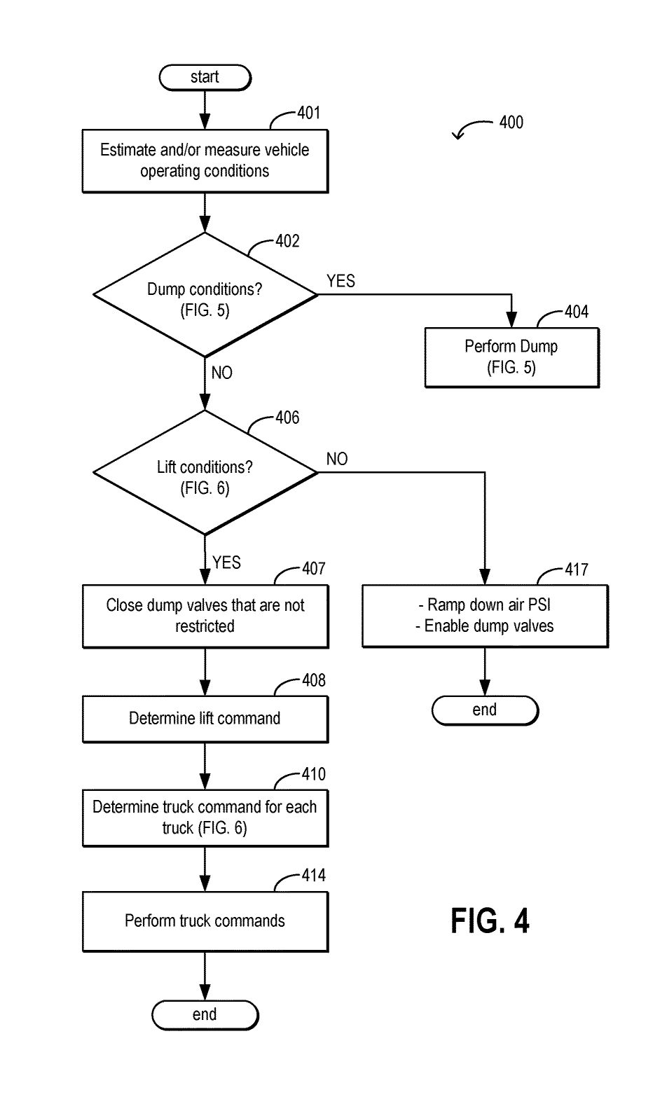

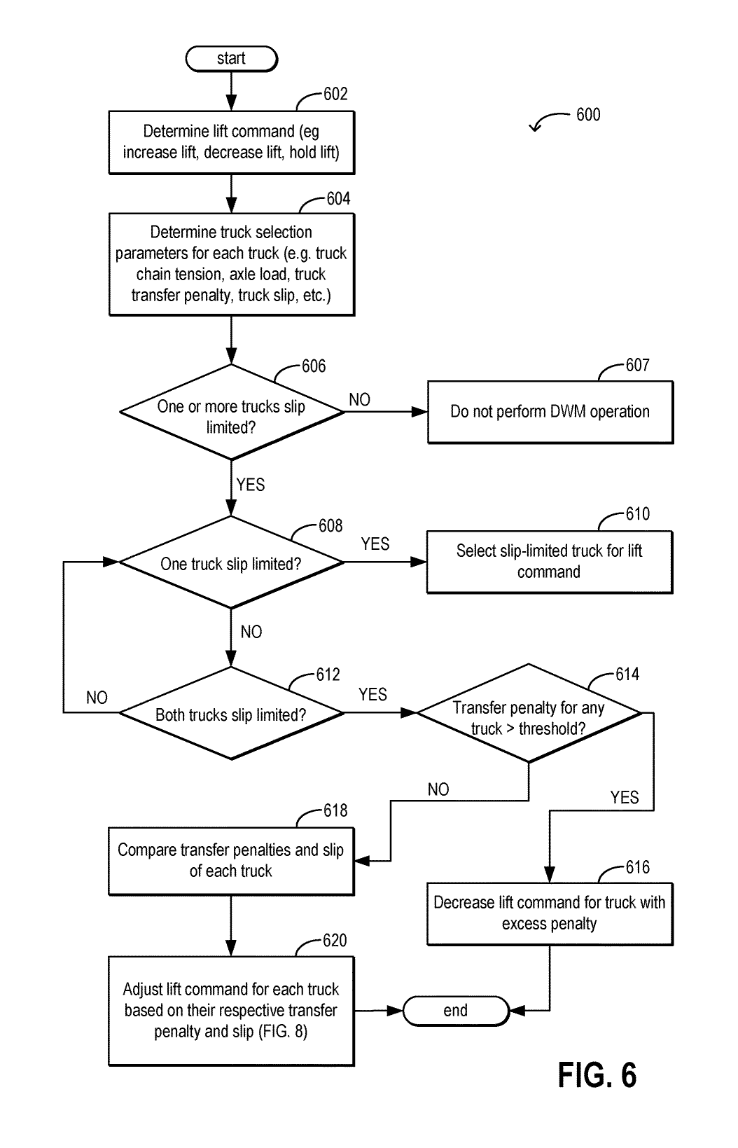

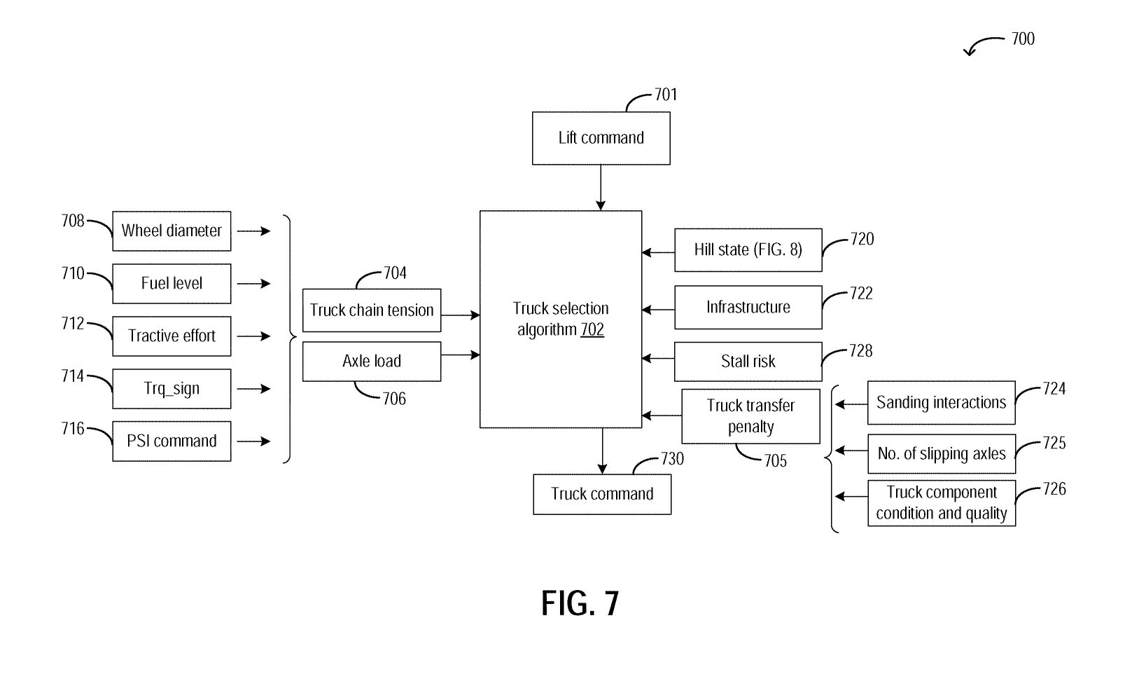

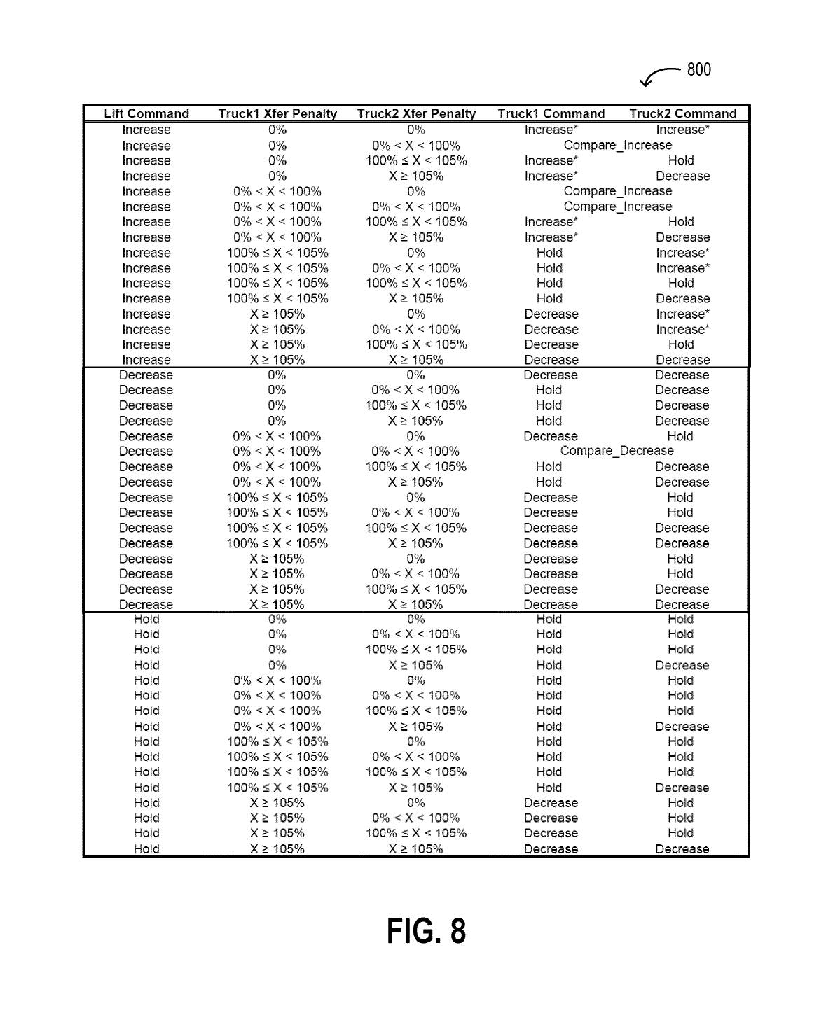

As illustrated with reference to FIG. 4, a vehicle control system may be configured to adjust the DWM by adjusting the actuation of the lift mechanism springs to provide a determined amount of lift based on vehicle operating conditions. As shown in FIGS. 6-7, based on the condition of each truck in the truck assembly, the controller may perform DWM control by selecting one or both of the trucks for performing the determined amount of lift. As such, while selecting the truck and adjusting the truck command, the controller may take into consideration various operating parameters such as truck-specific component stress, truck-specific wheel slippage, truck-specific axle loads, forward vs. rear truck location, etc. The lift commanded to each truck (or truck command) may be further adjusted based on the state of infrastructure, such as a track condition, a track grade, sanding interactions, the potential risk of a vehicle stall, vehicle braking, etc. If the control system determines that the conditions are not favorable for a lift to be performed on a particular truck, for example in the event of excess chain tension on a particular truck's lift mechanism, the controller may be further configured to reduce the lift on that truck, thereby pre-empting potential lift command related issues. The concepts introduced herein are further clarified with reference to example control commands in FIG. 8.

In this way, by adjusting the lift mechanism of a locomotive in a truck-specific manner, the tractive force and weight applied by each truck on the rail may be adjusted dynamically responsive to truck and locomotive operating conditions. By dynamically redistributing the locomotive load between powered and unpowered axles, it may be possible to reduce the stress of the lift mechanism during increased traction. Likewise, by dynamically redistributing and adjusting the amount of lift between truck lift mechanisms based on truck conditions, it may be possible to provide the determined lift without adding excess stress on any truck. By reducing the lift commanded to a truck during operating conditions where the truck has substantial stress, the useful life of the truck components may be increased.

FIG. 1 illustrates a system 10 including a locomotive 18. However, in alternate examples, the embodiment of system 10 may be utilized with other vehicles, including wheeled vehicles, other rail vehicles, and track vehicles. With reference to FIG. 1, the system 10 is provided for selectively and/or dynamically affecting a normal force 70, 72, 74 applied through one or more of a plurality of locomotive axles 30, 32, 34, 36, 38, 40. The locomotive 18 illustrated in FIG. 1 is configured to travel along a track 41, and includes a plurality of locomotive wheels 20 which are each received by a respective axle 30, 32, 34, 36, 38, 40. Track 41 includes a pair of rails 42. The plurality of wheels 20 received by each axle 30, 32, 34, 36, 38, 40 move along a respective rail 42 of track 41 in a travel direction 24.

As illustrated in the example embodiment of FIG. 1, the locomotive 18 includes a pair of rotatable trucks 26, 28 which are configured to receive a respective plurality of axles 30, 32, 34, and 36, 38, 40. Trucks 26, 28 may include truck frame element 60 configured to provide compliant engagement with carriers (not shown), via a suspension (not shown). The pair of trucks 26, 28 are configured to be rotated, where one or both of the trucks 26, 28 may be rotated 180 degrees from a forward direction, to a rear direction.

Each truck 26, 28 may include a pair of spaced apart powered axles 30, 34, 36, 40 and a non-powered axle 32, 38 positioned between the pair of spaced apart powered axles. The powered axles 30, 34, 36, 40 are each respectively coupled to a traction motor 44 and a gear 46. Although FIG. 1 illustrates a pair of spaced apart powered axles and a non-powered axle positioned there-between within each truck, the trucks 26, 28 may include any number of powered axles and at least one non-powered axle, within any positional arrangement.

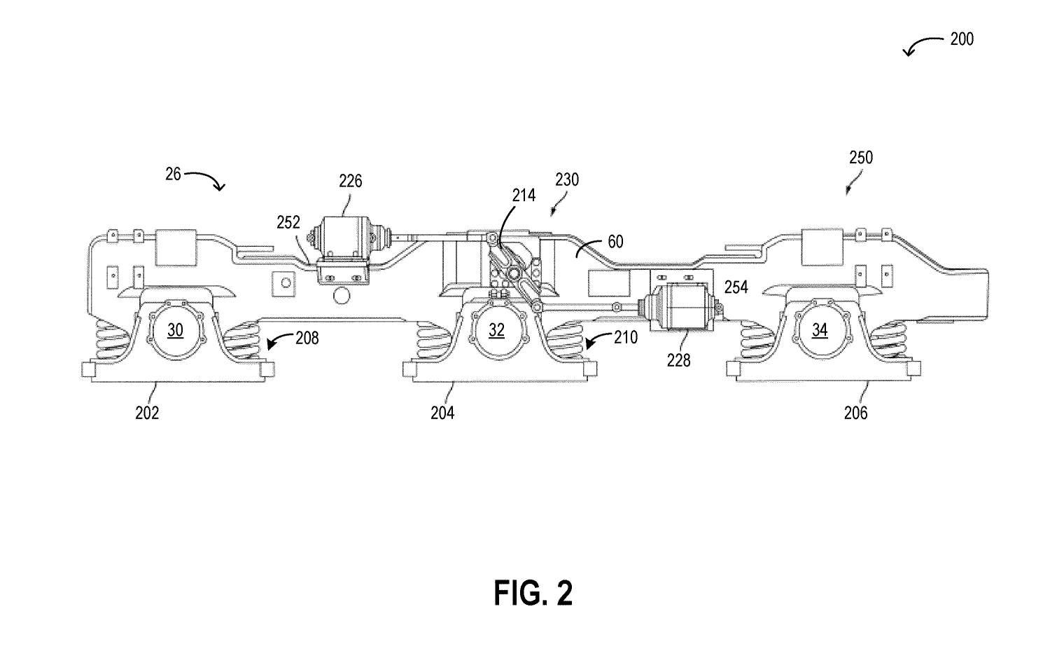

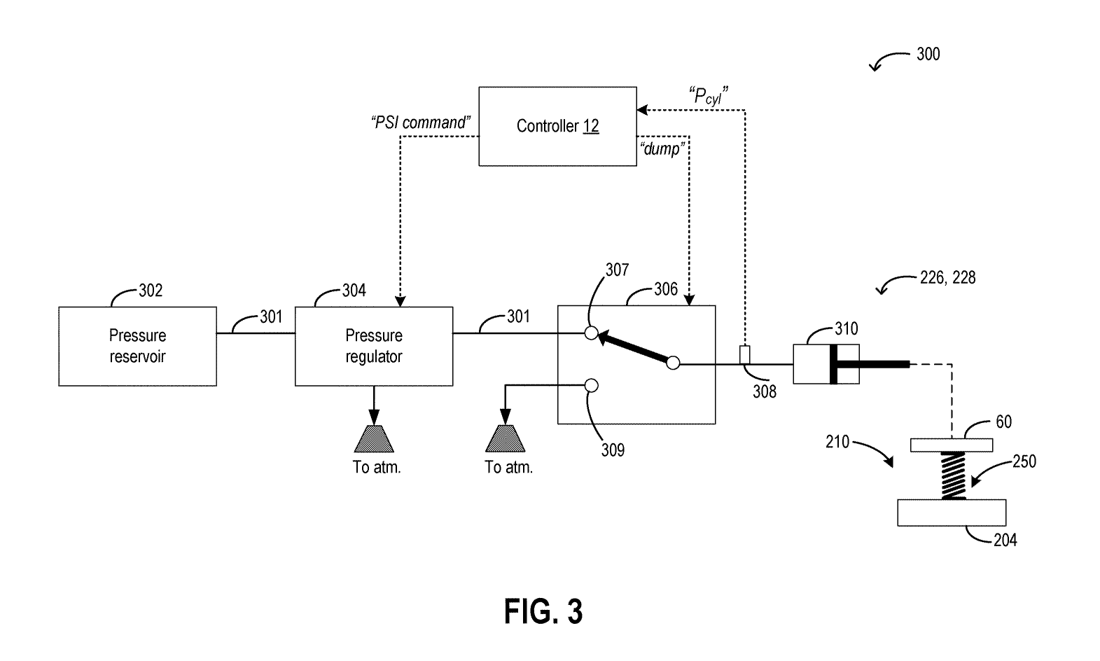

Each of the powered axles 30, 34, 36, and 40 include a suspension 90, and each of the non-powered axles 32 and 38 include a suspension 92. The suspensions may include various elastic and/or damping members, such as compression springs, leaf springs, coil springs, etc. In the depicted example, the non-powered axles 32, 38 may include a DWM actuator (not shown) configured to dynamically adjust a compression of the non-powered axle suspensions by exerting an internal compression force (as described with regard to FIGS. 2-3). The DWM actuator may be, for example, a pneumatic actuator, a hydraulic actuator, an electromechanical actuator, and/or combinations thereof. A vehicle controller 12 may be configured to activate the DWM actuators in response to a lift command, thereby activating the suspensions of the lift mechanism and performing dynamic weight management (DWM). By adjusting the compression of the non-powered axle suspensions, weight may be dynamically shifted from the non-powered axle 32 to the powered axles 30, 34 of truck 26. In the same way, dynamic weight shifting can also be carried out in truck 28. As such, it is possible to cause an upward force on the non-powered axles 32, 38 and increase the tractive effort of the locomotive 18 via a corresponding downward force on the powered axles 30, 34, 36, 40. For example, the weight imparted by the powered axles 30, 34 and 36, 40 on the track may be increased, while the weight imparted by the non-powered axles 32, 38 on the track is correspondingly decreased.

Returning to FIG. 1, as depicted, in one example, the locomotive is a diesel-electric vehicle operating a diesel engine 56. However, in alternate embodiments of locomotive 18, alternate engine configurations may be employed, such as a gasoline engine or a biodiesel or natural gas engine, for example. Alternatively, the locomotive may be fully electric. A traction motor 44, mounted on a truck 26, 28, may receive electrical power from alternator 50 via DC bus 52 to provide tractive power to propel the locomotive 18. As described herein, traction motor 44 may be an AC motor. Accordingly, an inverter 54 paired with the traction motor may convert the DC input to an appropriate AC input, such as a three-phase AC input, for subsequent use by the traction motor. In alternate embodiments, traction motor 44 may be a DC motor directly employing the output of the alternator after rectification and transmission along the DC bus. One example locomotive configuration includes one inverter/traction motor pair per wheel axle. As depicted herein, 4 inverter-traction motor pairs are shown for each of the powered axles 30, 34 and 36, 40.

A vehicle operator may control the operation of the locomotive by adjusting parameters input into a locomotive controller 12. For example, the vehicle operator may control the power output of the locomotive (thereby also controlling locomotive speed) by adjusting a throttle setting. The locomotive may be configured with a stepped or “notched” throttle (not shown) with multiple throttle positions or “notches”. In one example, the throttle may have nine distinct positions, including one idle notch corresponding to an idle engine operation and eight power notches corresponding to powered engine operation. Additionally, an emergency air brake application corresponding to an emergency stop position may also be included. When in the idle notch position, engine 56 may receive a minimal amount of fuel enabling it to idle at low at RPM. Additionally, the traction motors may not be energized. That is, the locomotive may be in a “neutral” state. To commence operation of the locomotive, the operator may select a direction of travel (herein, also referred to as a direction call) by adjusting the position of a reverser 14. As such, the reverser may be placed in a forward, reverse, or neutral position. Upon placing the reverser in either a forward or reverse direction, the operator may release a brake and move the throttle to the first power notch to energize the traction motors. As the throttle is moved to higher power notches, the fuel rate to the engine is increased, resulting in a corresponding increase in the power output and locomotive speed. In one example, as depicted, controller 12, reverser 14, and a vehicle operator may be positioned in cab 16 during locomotive operation.

Traction motor 44 may act as a generator providing dynamic braking to brake locomotive 18. In particular, during dynamic braking, the traction motor may provide torque in a direction that is opposite from the rolling direction thereby generating electricity that is dissipated as heat by a grid of resistors (not shown) connected to the electrical bus. In one example, the grid includes stacks of resistive elements connected in series directly to the electrical bus. Air brakes (not shown) making use of compressed air may be used by locomotive 18 as part of a vehicle braking system.

As noted above, to increase the traction of driven axles of the truck (by effecting a weight shift dynamically from at least one axle of the truck to at least another axle of the truck), one embodiment uses pneumatically actuated relative displacement between the un-powered axle (e.g., 32 and/or 38) and the truck frame element 60. The relative displacement of the un-powered axle causes a change (e.g., compression) of the axle suspension 92, thus causing a shift of weight to the powered axles (and additional compression of the suspension 90) to compensate for the reduced normal force 72 at the un-powered axle. This action generates an increased normal force 70, 74 on the powered axles 30, 34, for example.

Referring now to FIG. 2, an example truck configuration 200 is shown including a lift mechanism (herein also referred to as a DWM mechanism) for dynamically redistributing weight between powered and un-powered axles. While the depicted example represents an example truck configuration in the front truck 26 of FIG. 1, a similar configuration may also be included in the rear truck 28. As depicted, truck 26 may include a truck frame element 60 configured for compliant engagement with carriers 202, 204, 206, via the lift mechanism. In the embodiment of FIG. 2, springs systems 208, 210, 212 represent the vehicle lift mechanism. Each carrier 202, 204, 206 may be configured to hold respective axles 30, 32, 34. Specifically, the carriers may be configured as cylindrical bushings, or the like, configured to carry the axle. Each spring system 208, 210, 212 provides a structure configured to support respective portions of the truck frame element 60, and portions of the overlying weight of the locomotive 18, and thereby bias the truck frame element 60 upward, and away from the carriers 202, 204, 206.

In some examples, portions of the weight supported by each carrier 202, 204, 206, and consequently the upward normal forces 70, 72, 74, on each of the wheels 20 may be selectively, and in some examples, dynamically, redistributed among the carriers 202, 204, 206. In some examples, the weight may be redistributed via a weight transference configured to decrease the weight on the non-powered axle 32, thereby increasing the weight on the powered axle 30, 34 and consequently the tractive effort of the locomotive 18 via a corresponding increase in the normal forces 70, 74 on the powered wheels. Truck 28 may also be similarly constructed such that the weight on the non-powered axle 38 may be decreased, increasing the weight on the powered axles 36, 40 and consequently the tractive effort of locomotive 18.

Various actuating arrangements may be employed to reduce the weight on the non-powered axle 32. For example, a pair of actuators 226, 228 may be coupled with the truck frame element 60. A first actuator 226 may be coupled to, or near, a top surface 252 of the truck frame element 60, and a second actuator 228 may be coupled to, or near, a lower surface 254 of the truck frame element 60. The actuators may be configured to share the actuating load for actuating a linkage arrangement 230. Specifically, the actuators may each generate forces in opposite directions, yet offset from one another, to generate a coupling torque that rotates a cam or lever arm to generate lifting force on carrier 204 to displace it relative to, and toward, truck frame element 60. Mechanical advantage may be used by the linkage arrangement to amplify the force from the actuators, and in some examples the mechanical advantage may vary depending on the position of the linkage arrangement. In one example, the actuators 226, 228 may be pneumatic actuators (as elaborated in FIG. 3). In alternate examples, additionally or optionally, hydraulic and/or various direct or indirect actuators may be used, including, but not limited to using one or more servo motors, and the like. Various configurations and numbers of actuators may be employed. In alternate embodiments, the actuators could be coupled to both powered and non-powered axles.

The actuatable linkage arrangement 230 includes a compliant linkage coupled with the carrier 204 to translate rotation of a lever arm 214 by the pneumatic actuator-generated couple into vertical motion of the carrier 204 relative to the truck frame element 60. Lever arm 214 may be coupled with a crank (not shown) and may be configured to effect the pivoting of the crank. The two actuators 226, 228 may be configured to exert forces from respectively opposite directions to exert a couple on the lever arm 214. In one example, the compliant linkage may include a chain. In alternate examples, the linkage may include a cable, a strap, a rope, slotted rigid members, or the like. The chain may be able to operate in tension (hereafter referred to as a truck chain tension) to support a load at least an order of magnitude, and often two or more orders of magnitude, greater than that in compression. By enabling the compliant linkage to pull the carrier against the bias in a first direction, it is possible to selectively control increased compression of the carrier toward the truck frame element to effect a dynamic re-distribution of the load to other axles of the truck assembly.

Spring system 210 may include one or more springs 250 configured to couple the axle to the truck frame element 60. While FIG. 2 shows two springs biasing each carrier away from the truck frame element 60, more or less springs may be used. A top end of each spring may be attached to the truck frame element 60, and a bottom end of each spring to a carrier 204. In one example, as illustrated in FIG. 2, the spring system 208 for powered axle 30 may be substantially similar to the spring system of each powered axle 34, 36, and 40, such as when the locomotive can operate in both forward and reverse directions. However, in an alternative example, a front truck may require a greater lift force to compress the carrier 204 than on a rear truck due to the natural weight transfer within the truck or the locomotive. As such, the spring system 208 may be used only for axles 30 and 34, but not on axles 36 and 40. In one example embodiment, spring system 208 may be configured to provide a non-linear spring rate in response to a deflection between powered axles 30 and 34 and truck frame element 60. In alternate embodiments, spring system 208 may be linear and may provide a spring rate substantially similar to that of spring system 210.

Now turning to FIG. 3, an example embodiment 300 for pneumatic actuation of the suspension system (or lift mechanism) of FIG. 2 is illustrated. Based on a pressure command (“PSI command”) issued from controller 12, a pressure regulator valve 304 may be configured to provide air pressure along pneumatic line 301 to side cylinder 310 of each pneumatic actuator 226, 228. In one example, pressure regulator valve 304 may be a variable orifice pressure valve. Pressurized air may be supplied from pressure reservoir 302 to the pressure regulator 304. In one example, when a “ramp down pressure” is commanded by controller 12 (for example, in response to the absence of lift conditions), the pressure in pneumatic line 301 may be gradually ramped down by pressure regulator valve 304 by slowly dissipating pressurized air to the atmosphere (atm). In another example, when the pressure commanded is lower than the pressure supplied from the pressure reservoir, the difference in pressure may be dissipated to the atmosphere (atm) by the pressure regulator. In another example, there may be two valves which are independently controlled, one to increase the pressure and another to decrease the pressure, and the actual pressure regulation itself may be achieved by the controller using the pressure feedback. In one example, when the maximum pressure applied is limited, the line pressure may be estimated from the tractive effort obtained as well.

The pressure regulator may be coupled to side cylinder 310 along pneumatic line 301 via a dump valve 306. In one example, dump valve 306 may be an electromagnetic dump valve alternating between an open position 309 and a closed position 307. Specifically, dump valve 306 may remain in a default closed position 307 until enabled or activated by the passage of an electric current, at which time dump valve may shift to the open position 309. In response to a “dump” command, controller 12 may enable the dump valve and the pressure in pneumatic line 301 may be “dumped” to the atmosphere, rapidly and almost instantaneously bringing the air pressure in the line down, for example down to a range of 0-5 psi. In this way, a quick deactivation of the lift mechanism may be provided, for example, in response to a sudden application of friction brakes during an emergency air brake event. As such, the quick lift deactivation mechanism, that is “dump” operation, reduces sliding of the axle.

A controlled deactivation of the DWM mechanism may be used during a de-lift operation (that is, during an operation wherein the locomotive is changed from operating with lift to operating with no lift, or less lift). Similarly, as further elaborated with reference to FIG. 6, a controlled truck-specific deactivation of the DWM mechanism may be performed in response to select truck conditions, for example under conditions when a particular truck has excess stress or excess transfer penalty. It will be appreciated that while FIG. 3 depicts a single side cylinder communicating with a single spring of the spring system, a similar command may be given in parallel to another side cylinder communicating with the second spring of the spring system.

During a DWM lift operation, dump valve 306 may remain closed and pressure regulator valve 304 may generate a pressure in the pneumatic line 301 based on the commanded pressure. A pressure sensor 308 may monitor the pressure (P_{cyl}) in the line. The commanded pressure may be transferred to side cylinder 310. The movement of side cylinder 310 may then be relayed to and transformed into a corresponding lift in spring system 210. In one example, when an increase in lift is commanded (herein also referred to as a DWM lift), the movement of side cylinder 310 may enable springs 250 of spring system 210 to decrease their compression rate, thereby bringing carrier 204 closer to truck element 60. In another example, when a decrease in lift is commanded (or when a DWM de-lift is commanded), the movement of side cylinder 310 may enable springs 250 of spring system 210 to increase their compression rate, thereby pushing carrier 204 further from truck element 60. That is, the controller, when performing DWM control, is responsible for the air pressure on the DWM pneumatic cylinders, which in turn shift weight from non-powered to powered axles on the locomotive. In one example, a push mechanism is used to perform the DWM lift under some conditions and an alternate mechanism (such as a pull mechanism) is used to perform de-lift under different conditions.

The controller may be configured to adjust the lift mechanism of a selected truck to dump actuation pressure and reduce lift by opening at least one of a first regulator valve (for example, during a first operating condition) and a second dump valve (for example, during a second operating condition). For example, in response to a vehicle braking and/or when both trucks are restricted, the controller may adjust both the first and second lift mechanisms to reduce lift (for example, completely reduce lift to a zero lift state and provide no lift) by opening a dump valve of both the first and second lift mechanisms. That is, the controller may rapidly dump actuation pressure from both the first and second lift mechanisms. In comparison, during a condition where the vehicle is moving into a low gradient zone (from a high gradient zone), the controller may more slowly reduce lift (for example, slightly reduce lift to a decreased lift state) by opening the regulator valve on one or both lift mechanisms.

Referring now to the control operation as illustrated in FIGS. 4-8, a controller may be configured to adjust the DWM mechanism based broadly on locomotive performance characteristics. The controller may adjust the authority of the DWM operation based on predefined maximum and minimum weight limits on the powered and unpowered axles. In one example embodiment, the weight on the powered axle may be 95,000 lbs and the weight on the un-powered axle may be 15,000 lbs, and this 95/15 configuration may represent a condition of most aggressive DWM authority (that is, a condition of most weight on the powered axle, least weight on the un-powered axle, and highest DWM component and truck stress). The DWM operation may also be adjusted based on the vehicle speed. Thus, as a locomotive speed drops, the DWM authority may increase. The DWM controller may use an operating map including defined regions wherein weight shift may be increased on a truck if adhesion-limited axles are present on that truck. For example, the controller may permit a weight shift up to a weight of 90,000 lbs on the powered axles of a truck, as needed, unless a stall risk is detected. In case of a stall risk, a weight shift of up to 95,000 lbs on to the powered axle may be tolerated. Similarly, DWM weight limits may be enforced that would initiate a DWM de-lift action. Herein, the de-lift region limits may be higher than the lift region limits to provide a hysteresis to avoid cycling between lift and de-lift operations.

Now turning to FIG. 4, a routine 400 is described for selecting an amount of lift in the vehicle suspension system of FIG. 1 in response to vehicle operating conditions. The routine may be performed, for example, by the vehicle controller 12, at the start of and during vehicle operation, to dynamically redistribute the locomotive load between the powered and non-powered axles of the selected truck or trucks.

At 401, vehicle operating conditions may be estimated and/or measured. These may include estimating environmental conditions external to the vehicle, such as an ambient temperature, pressure, humidity, weather conditions, etc. A rail track condition (or quality of the track on which the vehicle travels) and a geographical input of the location along the rail track may be determined, for example based on information from a global positioning system (GPS) and/or from a track database. Operator inputs such as a requested notch, a reverser position (that is, a direction call), and a desired torque (for example, from a throttle position) may be determined. Further still, a fuel amount may be determined based on a fuel tank sensor. The number of locomotives and cabs in the consist may be determined. Further still, it may be determined whether the locomotive is in a short hood or long hood direction (that is, whether the short hood or long hood of the locomotive is in the front with respect to the locomotive's direction of travel). Similarly, various other vehicle operating conditions may also be determined.

The vehicle operating conditions estimated may also include truck conditions for each truck. These may include estimating an axle load on each truck, truck chain tension, a number of slipping wheels on each truck, presence of other truck restrictions, etc. In one example, a truck transfer penalty may be determined for each truck based on the various truck conditions and restrictions estimated, particular to each truck. As such, the truck transfer penalty may be a numerical representation of the amount of stress on the truck.

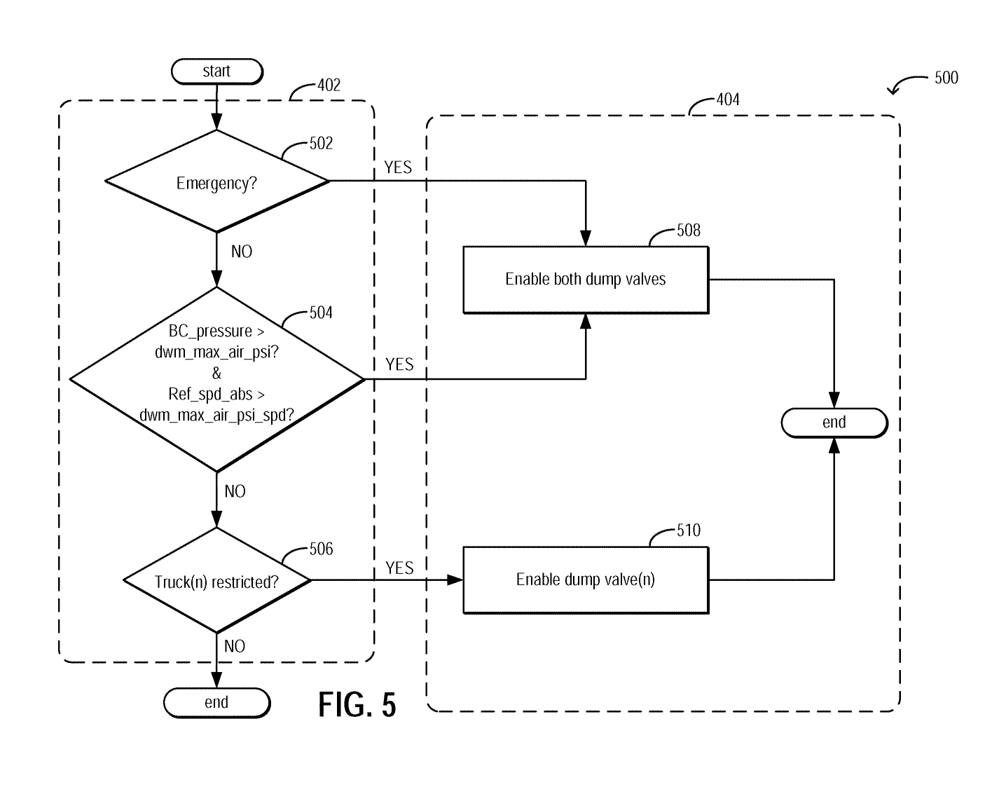

At 402, it may be determined whether any dump conditions are present. As such, the dump conditions may correspond to vehicle operating conditions and/or locomotive component conditions under which the performance (or maintenance) of a lift operation and the redistribution of weight may adversely affect the vehicle performance and/or the operating condition of locomotive components (for example, by increasing axle sliding and slip). That is, conditions wherein a lift may not be desired. These may include, for example, emergency air brake application conditions. Thus, under such dump conditions, even if a lift could be performed, the lift operation may be over-ridden and a dump operation may be performed instead at 404. As such, this may represent an emergency mode of the control system wherein locomotive degradation due to a lift command may be anticipated and accordingly some or all of the lift may be “dumped”. Further details of an example dump operation are provided herein with reference to FIG. 5.

If no dump conditions are identified at 402, then at 406, lift conditions may be confirmed. That is, it may be confirmed whether the vehicle operating conditions permit a lift operation. In one embodiment, based on locomotive operating conditions including locomotive speed, locomotive notch, truck restrictions, motoring state of the vehicle, time elapsed since a previous lift and/or dump operation, the possibility of a stall (that is, a stall detection state), and/or the gradient of the track (that is, a hill detection state), a controller may determine a running state of the locomotive, for example, whether the locomotive is in a condition of starting with no lift, starting with lift, running with no lift, or running with lift. In one example, the controller may additionally determine whether a transition between the states is possible.

The routine may also be configured to limit or restrict an amount of lift, and thus an amount of weight transfer between axles, based on operating conditions such as the location of the locomotive and/or the rail condition. For example, if a specific section of rail (e.g., in a specific geographic region) can only support limited weight, when that section is reached, the lift operation may be limited. In one example, this may be achieved with the help of a geo-sensing system. The geo-sensing system may include a track database including information regarding the quality, grade, current condition, etc. of tracks along the route the locomotive is expected to travel. The system may also include information regarding the presence of bridges, and the condition of the bridges. Predetermined geographic zones may be stored on an on-board control system (OBS) of the locomotive and may include a location determination system, such as a GPS. In one example, the predetermined geographic zones may be set up as “non-permissible zones”, such that when the locomotive is approaching and/or transitioning through those zones, a weight shift operation is prevented. Alternatively, the predetermined geographic zones may be set up as “permissible zones”, such that when the locomotive is approaching and/or transitioning through those zones, a weight shift operation is allowed. The geographic zone restrictions may be implemented automatically or using manual inputs, such as by the operator enabling a switch or providing authorization from off-board the system using communications. In one example, such geographic zone-based weight transfer restrictions may be enforced alongside dump conditions and/or lift conditions, or may be enforced as limits on the lift command (for example, by assigning a zone-based maximum weight, maximum weight transfer, zone-based truck restriction, zone-based axle restriction, zone-based locomotive position restriction, etc.). In this way, by adjusting the weight transfer operation in an infrastructure-sensitive manner, detrimental track forces may be reduced and ride quality may be improved.

If no lift conditions are confirmed at 406, that is, if the locomotive is in a state of starting with no lift or running with no lift, the routine may move to 417 and ramp down the air pressure in the lift mechanism actuators (herein also referred to as lifters). That is, the air pressure in the lifters may be gradually reduced towards 0 psi (for example, by bringing it down to 5 psi) to avoid a lift. In one example, a controller may adjust the operation of an electro-pneumatic pressure regulator valve to gradually ramp down the pressure in the lifters. In another example the controller may command a valve to slow bleed the air down. If the air pressure has not reduced after a threshold time since the ramp down was initiated (for example, after 60 secs), the controller may enable both the dump valves and rapidly reduce the air pressure towards 0 psi. In comparison, if lift conditions are confirmed at 406, that is, if the locomotive is in a state of starting with lift or running with lift, the routine may move to 407 and close any dump valves that are not restricted.

Next, at 410, the routine may determine a lift command based on parameters such as the possibility of a locomotive stall, the presence of wheel slip, the gradient and state of the track, the vehicle operating conditions, etc. In one example, the controller may use a map representing lift condition operating areas as a function of vehicle speed and net tractive effort. Based on the position of the locomotive in the lift condition map, the lift options available under the given operating conditions may be determined. For example, based on the position of the locomotive on the map, it may be determined whether, at the given locomotive speed and the prevalent tractive effort, the locomotive may be started with a lift or run with lift, or whether the amount of lift may be increased, decreased, or held. In one example, a lift selection algorithm, receiving input from the various locomotive parameters, may be employed to determine the lift command (for example, to determine an amount and nature of lift). The determined lift command may indicate whether an amount of lift is to be increased, decreased, or held, and further to determine the rate at which the lift is to be increased or decreased.

Based on the lift command and further based on truck conditions, truck restrictions, and truck transfer penalties, at 410, a truck command may be determined for each truck (as further elaborated with reference to FIG. 6). A truck selection algorithm may be employed to select a truck (or trucks) for performing the DWM operation. As further elaborated herein with reference to FIG. 7, the truck selection algorithm may be configured to select a truck based on truck conditions, the load on the axle, the truck chain tension limits, sanding interactions, and the presence or possibility of axle slippage. In one example, when the locomotive is already in a condition of lift (for example, it is starting with lift or running with lift), a minimum lift may be commanded and held until the truck selection algorithm determines the truck command. At 414, the truck commands may be performed, that is, a pressure may be commanded to each truck activate the respective lifters and dynamically redistribute the weight between the axles in a truck-specific manner. In this way, the DWM mechanism may be operated to provide a lift and shift weight to powered axles only when it benefits the net tractive effort of the locomotive. By adjusting the amount of lift provided on each truck based on vehicle operating conditions, truck conditions, track conditions, etc., no unnecessary lift operation may be performed, and no more weight may be shifted between axles than is needed to facilitate the desired level of locomotive tractive effort performance.

Now turning to FIG. 5, routine 500 depicts an example dump operation that may be performed in response to the presence of dump conditions. As such, the dump conditions may represent conditions wherein a lift command, even if possible, may not be desired. Thus, the dump operation may take priority over a lift operation and thereby forestall potential issues arising from an undesirable lift operation. That is, the dump operation may enable a lift operation to be quickly deactivated.

At 502, it may be determined whether there are any emergency conditions. In one example, the emergency conditions may include the detection and/or prediction of undesirable amounts of unpowered axle wheel slide or negative creep. In another example, the emergency conditions may include the sudden application of emergency air brakes (or friction brakes). If emergency conditions are confirmed, at 508 the routine may enable both the dump valves of the suspension system to thereby provide no lift. As previously elaborated, by enabling both the dump valves, the air pressure in the pneumatic line of the lift actuators may be rapidly reduced, thereby quickly deactivating the lift operation.

If no emergency conditions are identified at 502, at 504 it may be determined whether the vehicle is in a braking mode. For example, it may be determined whether the brake cylinder pressure (BC_pressure) is greater than a threshold (dwm_max_air_psi), for example above 30 psi, and whether the vehicle speed (ref_spd_abs) is greater than a threshold (dwm_max_air_psi_spd), for example above 5 mph. If the conditions are confirmed at 504, then the routine may proceed to 508 and enable both the dump valves of the lift mechanism, thereby disabling a lift. In this way, an amount of lift may be rapidly disabled in response to vehicle air braking, thereby reducing unpowered axle slide risk.

If the conditions at 504 are not confirmed, then at 506, it may be determined whether dynamic weight management (DWM, that is, a weight redistribution operation) for either truck is restricted. For example, it may be determined whether any lift mechanism components have suffered degradation. In another example, it may be determined whether the load on a truck is high enough to cause potential issues (such as excessive journal box plate stress) when a lift command is applied. In yet another example, it may be determined whether the tractive effort produced by the powered axles in a truck is limited due to other reasons. If any or both of the trucks are restricted, then at 510, the corresponding dump valve (or valves) may be enabled to preclude that truck from performing a lift. Thus, in one example, during a (first) condition where the first truck (such as, a front truck) is restricted and the second truck (such as, a rear truck) is not restricted, a controller may adjust the (first) lift mechanism of the first truck to dump actuation pressure and reduce lift in the first truck. The first truck may be restricted, for example, due a detected degradation in first lift mechanism components. In another example, during a (second) condition where the second truck is restricted and the first truck is not restricted, a controller may adjust the (second) lift mechanism of the second truck to dump actuation pressure and reduce lift in the second truck. The second truck may be restricted, for example, due a detected degradation in second lift mechanism components. In one example, the lift mechanism of the trucks may be adjusted such that no lift is commanded to the restricted truck. It will be appreciated that additional or alternate dump conditions may also be confirmed in the dump operation of FIG. 5.

In still other examples, the controller may sequentially open a first regulator valve and then a second dump valve of the selected (restricted) truck or trucks based on vehicle operating conditions. In one example, in response to a “dump” command, or “ramp down pressure” command (that is, when a reduced amount of lift is requested or a de-lift operation is desired), the first regulator valve (for example, pressure regulator 304 in FIG. 3) of the selected truck(s) may start releasing pressure to the atmosphere. Concurrently, a timer may be started. Following the elapse of a threshold time, for example 60 seconds, the pressure in the pneumatic line may be determined (for example, by a pressure sensor). If the estimated pressure has not dropped below a threshold, and/or the rate of pressure drop is not above a threshold, and/or when the time has expired, the controller may then enable the dump valve of that truck(s) and “dump” the remaining pressure to the atmosphere. As such, the opening of the dump valve may enable a faster reduction in lift than the opening of the regulator valve.

As such, reducing lift may include reducing lift at a ramp-down rate, the ramp-down rate based on a level of lifting (that is, the amount of lift prevalent before the ramp-down was commanded), vehicle speed, track grade, and tractive effort. In one example, distinct variable orifice regulators may be provided for the lift mechanism on each truck. By using separate variable orifice pneumatic regulators on each truck, a separate degree of freedom may be provided for each truck such that the lift/de-lift operation on one truck may be performed distinct from the lift/de-lift operation on the other truck.

In this way, by performing a dump operation responsive to dump conditions or emergency conditions and conditions that may potentially impair locomotive operation, and by allowing the dump operation to take priority over a lift operation, locomotive degradation from lift operations may be reduced. By rapidly deactivating the DWM lift force responsive to emergency conditions, sliding of the unpowered axles may also be reduced. Similarly, by deactivating the lift mechanism of a particular truck in response to truck-specific restrictions, truck damage from lift operations may be reduced.

Now turning to FIG. 6, routine 600 depicts an example routine that may be used to select a truck for providing the determined amount of lift, and adjusting the truck command based on the truck selection. At 602, a lift command may be determined, as previously elaborated in FIG. 4. For example, it may be determined whether a lift is to be increased, decreased, or held. At 604, the truck selection parameters for each truck may be estimated. These may include, for example, estimating the truck chain tension, axle load, wheel slippage, transfer penalty, and other restrictions for each truck. As further detailed with reference to FIG. 7, the axle loads, chain tensions, and truck transfer penalties for each truck may be determined as a function of each truck's wheel diameter, truck orientation, tractive effort, etc.

The routine may determine a first truck penalty for the first truck based on first truck conditions and a second truck penalty for the second truck based on second truck conditions. Truck conditions determined may include truck slippage, truck-specific lift mechanism component conditions, truck-specific traction motor temperature, truck sanding interactions, truck wheel diameters, truck orientation, and truck-specific tractive effort.

At 606, it may be determined whether one or more trucks are slip limited or adhesion limited. If neither truck is slip limited, the DWM operation may not be performed, at 607. That is, the lift operation may be performed only to improve traction. If one or more trucks are adhesion limited, then at 608, it may be determined whether one truck is slip limited. If only one truck is slip limited, then at 610, the slip-limited truck may be selected for the lift operation. That is, the lift mechanism of the slip-limited truck may be adjusted to provide the determined amount of lift while the lift mechanism of the other truck may be adjusted to provide no lift. Thus, during a first condition when the wheels of the first truck, and not the second truck, are slipping, the first lift mechanism, and not the second lift mechanism, may be adjusted to provide the determined amount of lift. Similarly, during a second condition when the wheels of the second truck, and not the first truck, are slipping, the second lift mechanism, and not the first lift mechanism, may be adjusted to provide the determined amount of lift. At 612, it may be determined if both trucks are slip-limited. If both trucks are slip-limited, then the controller may then proceed to select a truck based on each truck's transfer penalty and amount of slip. Specifically, at 614, it may be determined whether the transfer penalty of any truck is greater than a threshold. As such, the threshold may represent a value above which the truck may be determined to have excess stress and at which stress level, a lift operation may reduce the operative life of the truck. Accordingly, if any truck is determined to have high transfer penalty (and excess stress), at 616, a decrease lift may be commanded to that truck.

If neither truck has a transfer penalty that is beyond the threshold, then at 618, the routine may proceed to compare the transfer penalty of the two trucks. Further, the routine may compare the slip condition on each truck, including, a number of slipping axles, a total amount of truck, the effect of any sanding operation on the truck, etc. Then, at 620, the routine may adjust the lift command for each truck based on the respective penalties and slips. Specifically, the routine may increase a DWM operation for the truck with the lower penalty and larger amount of slip. In this way, the first lift mechanism of the first truck may be adjusted based on operating conditions and the first truck transfer penalty while the second truck is adjusted based on operating conditions and the second truck transfer penalty. By increasing the lift on the truck which has higher slip-related tractive effort reduction, the tractive effort of the locomotive may be improved. With reference to FIG. 8, example truck commands are further described herein to further clarify the adjustment of the truck commands based on truck transfer penalties and slip limitations.

Table 800 of FIG. 8 lists example truck commands for a first truck (Truck1 command) and second truck (Truck2 command) of the locomotive based on the nature of the lift command (for example, increase, decrease, or hold) and further based on a transfer penalty (Xfer penalty) incurred for transferring a load to the first truck (Truck1 Xfer penalty) or to the second truck (Truck2 Xfer penalty). As previously indicated, each truck's transfer penalty may be computed based on, for example, the chain tension on each truck, the degree of wear and tear on each truck, an axle load on the truck, an amount of slip on the truck (in the presence and absence of sanding), an initial static weight of the axle, a final weight of the axle, etc.

In a first example, when the lift command is an increase in lift, and when there is no transfer penalty on either truck, both trucks may be commanded to increase an amount of lift, thereby allowing the weight distribution to be shared by both trucks. As such, the increase in lift truck command may be issued only if there is any slippage on each truck and if a sanding operation is active. In comparison, if one truck, (for example, truck2), has a high transfer penalty (for example, between 100% and 105%) while the other truck (truck1) has none, then a hold may be commanded to that truck (truck2) while the other truck (truck1) is commanded to increase lift. If one truck (truck2) has a transfer penalty greater than an upper limit (for example, above 105%), then a decrease lift may be commanded to that truck to reduce potential lift-related damages to the trucks, while the other truck (truck1) is commanded to increase lift. As such, a transfer penalty above 105% implies excessive truck or rail stress.

When the lift command is an increase in lift, and when one truck (for example, truck1) has no transfer penalty and the other truck (for example, truck2) has a transfer penalty within a range (for example, between 0 and 100%), a “compare_increase” truck command may be issued. Herein, a controller may compare the amount of slip, the number of slipping axles, the state of sanding, and the transfer penalty, of each truck to determine individual truck commands. For example, if the number of slipping axles on both trucks is greater than a threshold and sanding is active, and further if the transfer penalty of truck1 is lower than the transfer penalty of truck2, then the controller may issue an increase lift command to truck1 and a hold command to truck2. In comparison, if the transfer penalty of truck2 is lower than the transfer penalty of truck1, then the controller may issue an increase lift command to truck2 and a hold command to truck1. In another example, when sanding is active, and there are slipping axle(s) on truck 1 no slipping axles on truck 2, the controller may issue an increase lift command to truck1 and a hold command to truck2. In comparison, if there are no slipping axles on truck 1, and there are slipping on axles on truck 2, the controller may issue an increase lift command to truck2 and a hold command to truck1. If neither truck has slipping axles, the controller may issue a hold command to both trucks. As illustrated in some of the other examples listed in table 800, an increase lift, decrease lift, or hold lift truck command may be adjusted between the trucks, in response to an increase lift command, based at least on the transfer penalty of each truck. In each case, the slip limits are determined as a complex function of the amount of tractive effort and the vehicle speed.

In a second example, when the lift command is a decrease in lift, and when there is no transfer penalty on either truck, both trucks may be commanded to decrease an amount of lift. In comparison, if one truck, (for example, truck2), has a higher transfer penalty (for example, between a range such as 0 and 100% or 100% and 105%, or more than a threshold, such as 105%) while the other truck (truck1) has none, then a hold may be commanded to the truck with no penalty (truck2) while the truck with the higher transfer penalty is commanded to decrease lift.

When the lift command is a decrease in lift, and when both trucks have a transfer penalty within a range (for example, between 0 and 100%), a “compare_decrease” truck command may be issued. Herein, a controller may compare the transfer penalty of each truck to determine individual truck commands. For example, if the transfer penalty of truck1 is lower than the transfer penalty of truck2, then the controller may issue a decrease lift command to truck2 and a hold command to truck1. In comparison, if the transfer penalty of truck2 is lower than the transfer penalty of truck1, then the controller may issue a decrease lift command to truck1 and a hold command to truck2. As illustrated in some of the other examples listed in table 800, a decrease lift, or hold lift truck command may be adjusted between the trucks, in response to a decrease lift command, based at least on the transfer penalty of each truck.

In a third example, when the lift command is a hold lift, and when there is no transfer penalty on either truck, both trucks may be commanded to hold lift. Both trucks may also be commanded to hold lift if one truck has no transfer penalty and the other truck has a transfer penalty within a range (for example, between 0 and 100% or 100% and 105%). In comparison, if one truck, (for example, truck2), has a transfer penalty higher than a threshold (for example, more than 105%), while the other truck (truck1) has none, then a hold may be commanded to the truck with no penalty (truck1) while the truck with the higher transfer penalty is commanded to decrease lift. As illustrated in some of the other examples listed in table 800, a decrease lift, or hold lift truck command may be adjusted between the trucks, in response to a hold lift command, based at least on the transfer penalty of each truck. Additionally, the weight transfer mechanism may also be used during a dynamic brake operation.

Now turning to FIG. 7, an example control system 700 is depicted that may be used to determine respective truck commands. Truck selection algorithm 702 may be configured to calculate a truck command 730 based at least on a determined lift command 701. Specifically, the truck selection algorithm 702 may be configured to select a truck to provide the desired lift and further adjust the lift commanded to each truck based on respective truck conditions restrictions.

Truck selection algorithm 702 may be configured to continuously calculate an axle load 706 and a truck chain tension 704 for each truck using a mathematical model. As such, an upper limit of truck chain tension may be based on the mechanical link between the lift mechanism's chain (or complaint linkage) and the lift mechanism's journal box plate. In one example, the truck chain tension for each truck may be no more than 36000 lbs when the locomotive is running and the lift mechanism is operating with 136 psi air pressure. Beyond this limit, the journal box plate may endure excess stress. The truck chain tension limit may be further adjusted by the algorithm based on a degree of wear and tear on each truck. For example, in the presence of a higher degree of wear and tear, the truck chain tension limit for a given truck may be reduced. While the present example illustrates the truck command being adjusted based on lift chain tension, in alternate embodiments, the suspension margin (that is, how close the axle bearing housing is to the truck frame) may also be accounted for.

Both the truck chain tension and the axle load for each truck may be inferred from locomotive parameters including, for example, a wheel diameter 708, a fuel level 710, a tractive effort 712, a torque direction 714 (Trq_sign), and a brake cylinder pressure amount or command 716 (PSI_command).

The wheel diameter 708 may have an inverse correlation with the truck chain tension and axle load. As such, wheel diameter 708 may represent an input regarding the diameter of the 3 wheels on a given truck of the locomotive. In one example, as the powered axle wheel diameters are reduced as compared to the unpowered axle, the net truck chain tension on the given truck may increase. Consequently, a larger pressure command (truck command) may be required to produce the desired powered axle weight. The fuel level 710 may be determined by a fuel level monitor, for example. Full fuel levels, as compared to a reduced fuel level, would require less lift force for a given powered axle weight. Thus, in the above mentioned example, when the fuel tank is full, and the wheels of a given truck are of equal diameter, the chain tension required for a given powered axle weight may be 36,000 lbs, while at substantially empty fuel levels, the lift mechanism for that truck may be required to make more chain tension for the same resultant powered axle weight. In one example, when the locomotive is operating with a full tank (for example, with 5000 gallons of fuel), the powered axle weight will be larger. The per-axle tractive efforts may also influence powered axle weights. In addition to the fuel level, the position of the fuel tank may also be considered. For example, when the fuel tank is positioned in the rear of the locomotive, and the fuel tank is full, the truck commands may be adjusted so that the lift mechanism of the front truck, and not the rear truck, provides the determined amount of lift. Alternatively, the truck commands may be adjusted so that the lift mechanism of the front truck provides a larger amount of lift than the lift mechanism of the rear truck. As the fuel is consumed and the fuel level in the fuel tank reduces, the amount of lift commanded to the rear truck may be increased.

The direction of the tractive effort may also be a factor in dynamic axle weights. The torque direction (Trq_sign) 714 may depend on the configuration of the locomotive. For example, the torque may be produced in the forward direction when the locomotive is in the short hood configuration while in the long hood configuration, the torque may be produced in the reverse direction. As such, the short hood configuration refers to a configuration where the shorter of the two hoods (that is, the narrower sections of the locomotive body in front and behind of a cab) is in the front. The short hood may contain ancillary locomotive equipment. In comparison, the long hood configuration refers to a configuration where the longer of the two hoods is in the front. As such, the long hood contains the engine, alternator, inverter, generator, and other key locomotive operation equipment. Similarly, the tractive effort of each truck may depend on the directional configuration of the truck vis-a-vis the orientation of the locomotive. For example, under some conditions, the tractive effort of a forward truck may be different from the tractive effort of the rearward truck. In one example, when the first truck is positioned forward in a direction of travel, compared with the second truck, a lift may be commanded to the first truck's lift mechanism and not the second truck's lift mechanism. In another example, when the first truck is positioned rearward in a direction of travel, compared with the second truck, a lift may be commanded to the second truck's lift mechanism and not the first truck's lift mechanism. In still other examples, the truck commands may be adjusted based on the grade and the orientation of the trucks. For example, when the vehicle is travelling uphill, the front truck may be commanded a lower lift than the rear truck.

Based at least on the presence or absence of a fraction braking condition, as determined by PSI command 716, the axle weights may vary. For example, in the presence of braking, the estimated axle weight of each truck will be based on the ratio of brake levers, the total axle force applied on the brake shoes, the frictional force between the brake shoe and the wheel, a condition of the brakes (for example, the degree of wear on the brake shoes) etc.

The algorithm may also be configured to continuously calculate DWM component stresses and/or truck parameters which may need to be controlled or restricted. Specifically, truck selection algorithm 702 may be configured to continuously calculate a transfer penalty 705 for each truck. As such, this penalty is a composite representation of rail and truck stress due to the DWM action (that is, lift operation) of weight shift. As previously elaborated, the algorithm may determine a first truck penalty for the first truck based on first truck conditions and a second truck penalty for the second truck based on second truck conditions, the truck conditions including truck slippage (that is, a number of slipping axles and/or wheels), truck-specific lift mechanism component conditions (for example, truck chain tension limits), truck-specific traction motor temperature, truck sanding interactions, truck wheel diameters, truck orientation, and truck-specific tractive effort. For example, if it is determined that the traction motor temperature of a first truck is higher than a threshold, that truck may be limited and the amount of lift commanded to that truck may be reduced and the amount of lift commanded to the truck with a lower traction motor temperature may be increased.

When calculating the transfer penalty, the algorithm may consider the presence or possibility of potential slippage. Herein, the algorithm may determine and compensate for a total amount of slip, a number of slipping axles 725, the identity of the slipping truck, etc. In one example, the number of slipping axles 725 may be calculated by determining if any of the axles are slipping at more than a threshold value, such as at more than 1 rad/sec. Based on the presence of slip, an amount of lift may be adjusted, for example, reduced. In one example, when the wheels of a first truck, and not a second truck, are slipping, a lift may be commanded to the first truck's lift mechanism and not the second truck's lift mechanism. In another example, when the wheels of the second truck, and not the first truck, are slipping, a lift may be commanded to the second truck's lift mechanism and not the first truck's lift mechanism. In still another example, when the wheels of both the first truck and second truck are slipping, slippage of the first truck being larger than slippage of the second truck, the lift mechanism of the first truck may be commanded to increase lift while adjusting the second lift mechanism to reduce lift. In yet another example, when the wheels of both the first truck and second truck are slipping, slippage of the first truck being larger than slippage of the second truck, the lift mechanism of the first truck may be commanded to increase lift by a first larger amount while the lift mechanism of the second truck may be commanded to increase lift by a second smaller amount.

Additionally, the algorithm 702 may consider sanding interactions 724. The sanding interactions 724 may enable sanding control to be coordinated with the lift control to reduce the amount of dynamic weight redistribution. For example, in response to slip, a controller may first attempt to sand the rails. Then, in response to the effect of the sanding on the slip, an amount of lift may be adjusted. For example, if the sanding helps to reduce slip, the lift mechanism may not need to be activated. In another example, if the sanding does not help to reduce the slip and increase tractive effort, the lift operation may be increased. As such, sanding interactions 724 may also account for a weight of sand in a given truck's sand applicator. Similarly, the algorithm may compensate for a quality and condition of truck components 726, including, but not limited to, each truck's lift mechanism components, brakes, wheels, axles, etc.

The algorithm may also compensate for the presence of a stall risk 728. In one example, a stall state may be identified based on a vehicle speed decrease under a selected value. Based on the presence of a stall risk 728, the truck command may be adjusted. For example, in response to the presence of a stall risk, an amount of lift may be increased to thereby provide increased traction. That is, the dynamic weight management may be more aggressive if there is a risk of stall. Herein, more aggressive implies larger powered axle weights, lighter non-powered axle weights, and higher lift mechanism and truck component stresses.

The determined amount of lift may also be adjusted based on the state of infrastructure 722 along the route on which the locomotive is travelling (or will travel). For example, the first amount of lift provided by the first lift mechanism of the first truck and the second amount of lift provided by the second lift mechanism of the second truck may be restricted in response to an infrastructure condition, such as a reduced track quality, a reduced bridge quality, and/or a reduced ballast quality. The infrastructure condition 722 may be based on an on-board track database, a global positioning system (GPS), and/or other wireless communication, at any given time.

In addition, the amount of lift may be limited in response to environmental conditions, that is, conditions external to the vehicle, such as an ambient weather, temperature, pressure, and humidity. In one example, during higher ambient temperatures, the amount of lift may be limited to lower amounts to reduce heat stress on the wheels. Similarly, an amount of lift may be limited in the event of adverse weather conditions such as rain or snow. As such, when an amount of lift is to be increased or decreased, the controller may also determine a corresponding ramp-up rate or ramp-down rate, respectively. The ramp-up and/or ramp down rates may be based on parameters including, a level of lifting, a vehicle speed, and a tractive effort.

The transfer penalty variable, along with the consideration of which axles are adhesion-limited or slip-limited, are used by the algorithm in the truck selection and truck command adjustment process. If there are no axles that are adhesion-limited, then no more weight may be added to the powered axles in that truck. Consequently, if there is only one truck with an adhesion-limited axle, that is the truck which is selected to receive DWM action when more performance is needed. If both trucks have adhesion-limited axles, the penalty variable is used to make the truck selection for an increase in DWM lift. Similar logic is used for DWM de-lifts. Any truck with a penalty above a threshold may receive a de-lift action. If neither truck has an excessive penalty, then only the truck that has an adhesion-limited axle may receive the de-lift action. If both trucks are adhesion-limited, or neither truck is adhesion-limited, then the truck with the highest penalty may be selected for the de-lift command.

The vehicle may be configured with a first truck with a first lift mechanism and a second truck with a second lift mechanism. Based on the output of the truck selection algorithm, a controller may be configured to adjust the first lift mechanism and not the second lift mechanism during a first condition, and adjust the second lift mechanism and not the first lift mechanism during a second condition (different from the first condition). As previously elaborated with reference to FIG. 3, the lift mechanism on each truck may be adjusted separately using distinct variable orifice pneumatic regulators, thereby providing a separate degree of freedom for each truck.

The truck command may also be adjusted based on a hill state 720 or gradient of the track on which the locomotive is running, or will be running. In one example, the hill state or grade may be recalculated at the start of every vehicle operation. In another example, the grade or hill state may be determined from a previous vehicle shut-down (for example, by storing the details of the grade or hills state in a controller memory during the previous shut-down). In another example, the grade may be determined and/or adjusted based on input from a global positioning system included in the locomotive cab (for example, as part of an on-board control system). Based on the presence or absence of a hill condition (that is, a gradient), and further based on whether the lift is to be provided to the locomotive when starting on the hill or running on the hill, the determined amount of lift may be adjusted. As such, the weight distribution between the axles may be markedly distinct when starting the vehicle on a hill in comparison to starting the vehicle on a flatter ground. In one example, the amount of lift may be based on the grade of the vehicle during the initial movement of the vehicle from rest. For example, the determined amount of lift may be increased in response to an increase in grade. In another example, during a first grade, when the vehicle is travelling uphill, the lift mechanism of the (first) rear truck, and not the (second) front truck, may be adjusted to provide the determined amount of lift. In alternate examples, instead of providing no lift, the lift mechanism of the second truck may be adjusted to reduce lift. In still other examples, when the vehicle is travelling uphill, the lift mechanism of first truck may be adjusted to provide a first, larger amount of lift while the lift mechanism of the second truck is adjusted to provide a second smaller amount of lift. In comparison, during a second grade, when the vehicle is travelling downhill, the lift mechanism of the (second) front truck, and not the (first) rear truck, may be adjusted to provide the determined amount of lift. Similarly, the transitions between lift commands, that is, transitions among increasing lift, decreasing lift, and holding lift commands may be adjusted based on the grade. Further still, the lift command may be adjusted based on whether the locomotive is in a start condition, non-start condition, or restart condition.

In this way, a control system with a computer readable storage medium may be configured with instructions to determine a net lift amount based on vehicle operating conditions, and determine a truck transfer penalty for each of the (first and second) trucks based at least on truck conditions. The control system may then adjust the first lift mechanism of the first truck to provide a first lift amount based on the operating conditions and the first truck transfer penalty, and adjust the second lift mechanism of the second truck to provide a second lift amount based on the operating conditions and the second truck transfer penalty, such that the sum of the first lift amount and the second lift amount totals the net lift amount. That is, the control system may distribute the total amount of lift provided by the trucks based on each truck's condition.

It will be appreciated that a variety of lift command and truck command combinations may be possible, based on the vehicle operating conditions, to thereby adjust a vehicle lift mechanism. In one example, the adjustment may include, during a first operating condition, increasing a determined amount of lift, maintaining the determined amount of lift during a second operating condition, and decreasing the determined amount of lift during a third operating condition. In a second example, the adjustment may include, during a first vehicle operational range, maintaining the determined amount of lift in response to increased wheel slippage, and during a second vehicle operational range, increasing the determined amount of lift in response to increased wheel slippage. In this way, lift commands and corresponding truck commands may be dynamically adjusted responsive to vehicle operating conditions. By adjusting the lift commands and truck commands, the lift mechanism of the vehicle may be adjusted to thereby enable the dynamic weight redistribution.

In this way, a locomotive control system may dynamically adjust the operation of a locomotive suspension system to thereby adjust an amount of lift provided by the suspension system. By adjusting the amount of lift, weight may be dynamically redistributed between truck axles during locomotive operation. By performing adjustments to the lift operation to compensate for vehicle slip, sanding interactions, truck conditions, track gradients, etc., potential locomotive damage may be substantially reduced.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims. Moreover, unless specifically stated otherwise, any use of the terms first, second, etc., do not denote any order or importance, but rather the terms first, second, etc. are used to distinguish one element from another.

1. A method for controlling a vehicle having a first truck with a first lift mechanism and a second truck with a second lift mechanism, each of the first truck and second truck further configured with a plurality of axles, each of the first lift mechanism and second lift mechanism configured to dynamically transfer weight from one axle to another, the method comprising:
responding to an operating condition by adjusting the first lift mechanism different from the second lift mechanism.

2. The method of claim 1, wherein adjusting differently includes,
during a first operating condition, adjusting the first lift mechanism and not the second lift mechanism to provide a determined amount of lift; and
during a second operating condition, adjusting the second lift mechanism and not the first lift mechanism to provide the determined amount of lift.

3. The method of claim 2, wherein the first operating condition includes wheels of the first truck, and not the second truck, slipping, and wherein the second operating condition includes wheels of the second truck, and not the first truck, slipping.

4. The method of claim 3, wherein the adjustment includes, in response to wheel slip, providing no increase in lift to the truck with no wheel slip related tractive effort reduction.

5. The method of claim 2, wherein the first truck is a rear truck and the second truck is a front truck, and wherein the first operating condition includes the vehicle traveling uphill, and wherein the second operating condition includes the vehicle travelling downhill.

6. The method of claim 1, wherein adjusting differently includes, during a first condition, adjusting the first lift mechanism to increase lift while adjusting the second lift mechanism to reduce lift.

7. The method of claim 6, wherein the first condition includes truck component stress and/or axle weight of the second truck, and not the first truck, being above a threshold.

8. The method of claim 1, wherein adjusting differently includes, during a first condition, adjusting the first lift mechanism to increase lift by a first, larger amount and adjusting the second lift mechanism to increase lift by a second, smaller amount.

9. The method of claim 8, wherein the first condition includes, wheels of both the first truck and second truck being adhesion limited, and truck component stress and/or axle weight of the first truck having a greater margin from threshold values than that of the second truck.

10. The method of claim 8, wherein the first condition includes the second truck positioned forward, in a direction of travel of the vehicle, compared with the first truck.

11. The method of claim 1, further comprising, in response to vehicle braking and/or both trucks being restricted, adjusting both the first lift mechanism and the second lift mechanism to provide no lift, the adjusting to provide no lift including, opening a dump valve of the first lift mechanism and second lift mechanism to dump actuation air pressure from both the first lift mechanism and second lift mechanism.

12. The method of claim 1, wherein adjusting differently includes,
during a first condition, where the first truck is restricted and the second truck is not restricted, adjusting the first lift mechanism to dump actuation pressure and reduce lift in the first truck; and
during a second condition, where the second truck is restricted and the first truck is not restricted, adjusting the second lift mechanism to dump actuation pressure and reduce lift in the second truck.

13. The method of claim 12, wherein during the first condition, the first truck is restricted due to a detected degradation in first lift mechanism components, and wherein during the second condition, the second truck is restricted due to a detected degradation in second lift mechanism components.

14. The method of claim 12, wherein adjusting the first lift mechanism to dump actuation pressure and reduce lift includes opening at least one of a first regulator valve and a second dump valve of the first lift mechanism, and wherein adjusting the second lift mechanism to dump actuation pressure and reduce lift includes opening at least one of a first regulator valve and a second dump valve of the second lift mechanism.

15. The method of claim 12, wherein reducing lift includes reducing lift at a ramp-down rate, the ramp-down rate based on a vehicle speed, a track grade, and a level of lifting.

16. The method of claim 1, wherein adjusting includes, determining a first truck penalty for the first truck based at least on first truck conditions, and determining a second truck penalty for the second truck based at least on second truck conditions, and wherein during the first condition, the first truck has a higher truck penalty than the second truck, and wherein during the second condition, the second truck has a higher truck penalty than the first truck.

17. A method for a vehicle having a first truck with a first lift mechanism and a second truck with a second lift mechanism, each of the first truck and second truck further configured with a plurality of axles, each of the first lift mechanism and second lift mechanism configured to dynamically transfer weight from one axle to another, the method comprising,
determining a first truck transfer penalty for the first truck and a second truck transfer penalty for the second truck;
adjusting the first lift mechanism to provide a first amount of lift, the first amount of lift based on operating conditions and the first truck transfer penalty; and
adjusting the second lift mechanism to provide a second, different, amount of lift, the second, different, amount of lift based on operating conditions and the second truck transfer penalty.

18. The method of claim 17, wherein the first truck transfer penalty is based on first truck component stress, first truck rail stress and/or first truck axle weight, and wherein the second truck transfer penalty is based at least on second truck component stress, second truck rail stress and/or second truck axle weight, and further wherein the first and second lift mechanisms are further adjusted based on truck-specific lift mechanism component conditions, truck-specific traction motor temperature, truck sanding interactions, truck wheel diameters, truck orientation, and truck-specific tractive effort.

19. The method of claim 17, wherein the first amount of lift and second amount of lift are restricted in response to an infrastructure condition.

20. The method of claim 17, wherein the infrastructure condition includes at least one of a reduced track quality, a reduced bridge quality, and a reduced ballast quality.

21. The method of claim 17, wherein the infrastructure condition is based on a track database and/or a global positioning system.

22. A vehicle system, comprising,
a first truck including a first lift mechanism and a plurality of axles, the first lift mechanism configured to dynamically transfer weight from one axle to another;
a second truck including a second lift mechanism and a plurality of axles, the second lift mechanism configured to dynamically transfer weight from one axle to another; and
a control system with a computer readable storage medium and instructions for,
determining a net lift amount based on vehicle operating conditions;
determining a first truck transfer penalty for the first truck based at least on first truck conditions and a second truck transfer penalty for the second truck based at least on second truck conditions;
adjusting the first lift mechanism to provide a first lift amount, the first lift amount based on the vehicle operating conditions, the first truck transfer penalty, and the net lift amount; and
adjusting the second lift mechanism to provide a second lift amount, different from the first lift amount, the second lift amount based on vehicle operating conditions, the second truck transfer penalty, and the net lift amount, wherein the sum of the first lift amount and second lift amount totals the net lift amount.

23. The vehicle system of claim 22, wherein first truck conditions include truck slippage, truck lift mechanism component conditions, truck traction motor temperature, truck sanding interactions, truck wheel diameters, truck orientation, and truck tractive effort for the first truck, and wherein second truck conditions include truck slippage, truck lift mechanism component conditions, truck traction motor temperature, truck sanding interactions, truck wheel diameters, truck orientation, and truck tractive effort for the second truck.
